(19) United States
(12) Patent Application Publication
(10) Pub. No.: US 2014/0217832 A1
(43) Pub. Date: Aug. 7, 2014

(54) DISCONNECT SWITCHES IN DC POWER SYSTEMS

(71) Applicant: ASTEC INTERNATIONAL LIMITED, Kowloon (HK)

(72) Inventor: Vijay Gangadhar Phadke, Pasig City (PH)

(73) Assignee: ASTEC INTERNATIONAL LIMITED, KOWLOON (HK)

(21) Appl. No.: 13/760,753

(22) Filed: Feb. 6, 2013

(51) Int. Cl. H01H 9/54

(52) U.S. Cl. CPC H01H 9/54
USPC 307/112

(57) ABSTRACT

A system includes a soft DC power source having an output terminal, a DC load, a disconnect switch coupled between the output terminal of the DC power source and the DC load, and a capacitor coupled between a power side of the disconnect switch and a reference potential. The capacitor inhibits a rise in voltage across the disconnect switch as the disconnect switch is opening to inhibit arcing in the switch. Further, a disconnect switch assembly includes a pair of input terminals for coupling to a DC power source, a pair of output terminals for coupling to a DC load, a disconnect switch coupled between one of the input terminals and one of the output terminals, and a capacitor coupled between the pair of input terminals.

### FIELD

The present disclosure relates to disconnect switches in DC power systems.

### BACKGROUND

This section provides background information related to the present disclosure which is not necessarily prior art.

Disconnect switches are commonly used in electrical circuits for interrupting and/or preventing the flow of current between an electric power source and an electric load. For example, and as shown in FIG. 1, a disconnect switch S1 having a pair of contacts is typically coupled between a photovoltaic (PV) power source that supplies DC power and a solar inverter that converts the DC power to AC power. By opening the disconnect switch S1, the inverter may be electrically isolated from the PV power source (e.g., for servicing the inverter, etc.).

However, when there is a hard fault in the inverter, such as a short circuit across its input terminals (internally or externally), the PV power source is also short circuited. If the disconnect switch S1 is opened when a short circuit current from the PV source is flowing, a large voltage may develop across the switch. This large voltage across the switch, coupled with any wiring inductance L1, may result in extended arcing across the switch contacts.

One particular example of this is illustrated in FIG. 2 for a PV power source having a short circuit current of 6 ADC and an open circuit voltage of 450 VDC. At time t0, when the disconnect switch S1 begins opening, the voltage across the switch Vsw jumps from zero to a higher voltage V0, such as 250 VDC. Current lsw continues to flow through the switch due to extended arcing for about 250 msec, while the voltage across the switch Vsw rises. At time t1, the extended arcing ends, the current lsw ceases to flow, and the voltage across the switch Vsw rises to the open circuit voltage Voc (450 VDC in this example).

The extended arcing from time t0 to time t1 can produce a large amount of heat in the switch, which reduces its life. It can also permanently weld the contacts in the switch and thus prevent the switch from operating as intended.

It is also known to use a disconnect switch S1 having several pairs of switch contacts connected in series (e.g., a triple pole, single throw switch), as shown in FIG. 3. This reduces the amount of voltage across each pair of contacts to reduce arcing. However, using multiple pairs of switch contacts increases the physical size and cost of the disconnect switch.

### SUMMARY

This section provides a general summary of the disclosure, and is not a comprehensive disclosure of its full scope or all of its features.

According to one aspect of the present disclosure, a system includes a soft DC power source having an output terminal, a DC load, a disconnect switch having a power side and a load side coupled between the output terminal of the soft DC power source and the DC load, and a capacitor coupled between the power side of the disconnect switch and a reference potential. The capacitor inhibits a rise in voltage across the disconnect switch as the disconnect switch is opening to inhibit arcing in the switch.

According to another aspect of this disclosure, a DC disconnect switch assembly includes a pair of input terminals for coupling to a DC power source, a pair of output terminals for coupling to a DC load, a disconnect switch coupled between one of the input terminals and one of the output terminals, and a capacitor coupled between the pair of input terminals.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of system employing a disconnect switch between a photovoltaic (PV) power source and a solar inverter according to the prior art.

FIG. 2 illustrates the extended arcing that can occur in the disconnect switch of FIG. 1 as the switch is opening.

FIG. 3 is a block diagram of another prior art system employing a disconnect switch with multiple contact pairs connected in series to reduce arcing.

FIG. 4 is bock diagram of a system including a disconnect switch according to one example embodiment of the present disclosure.

FIG. 5 is a block diagram of the system of FIG. 4, but with a resistor coupled in series with the capacitor on the input side of the disconnect switch.

FIG. 6 is a block diagram of one example implementation of the system of FIG. 5, where the DC power source is a photovoltaic (PV) power source and the DC load is an inverter coupled to a utility grid.

FIG. 7 is a graph illustrating voltage and current waveforms for the disconnect switch in FIG. 6 as the disconnect switch is opening with a short circuit condition on its load side.

FIG. 8 is a block diagram of a DC disconnect switch assembly according to another embodiment of the present disclosure.

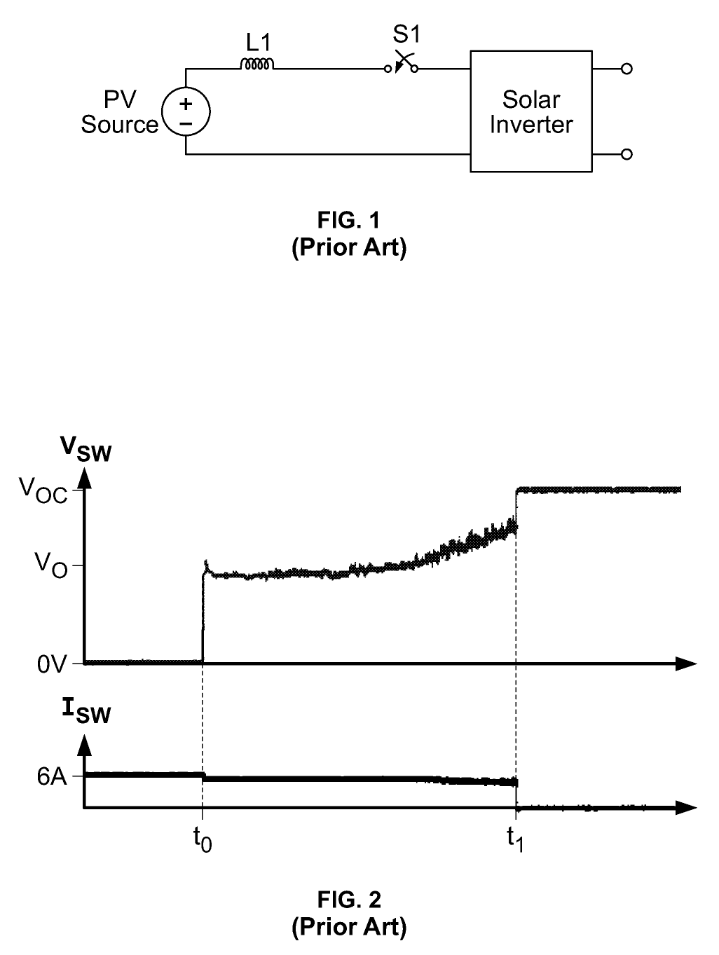

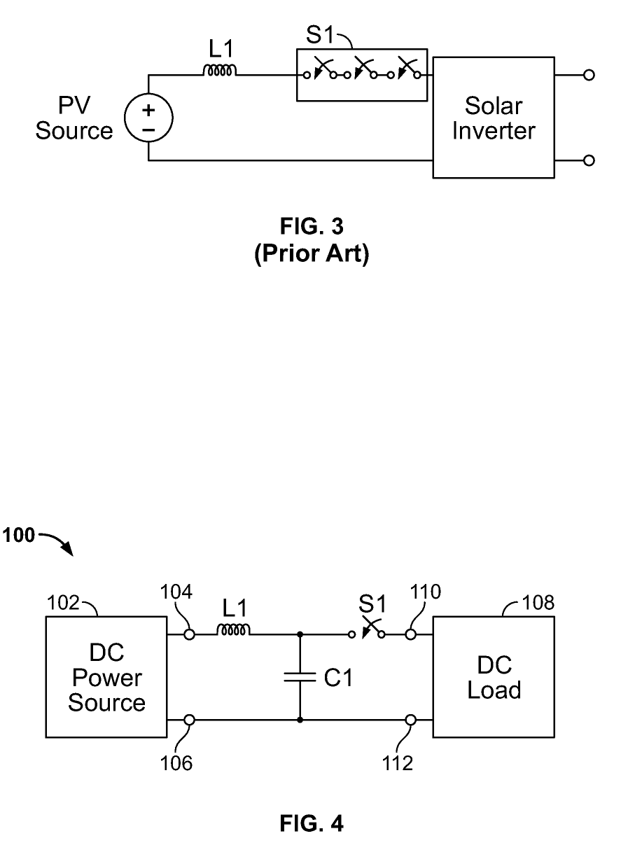

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A system according to one example embodiment of the present disclosure is illustrated in FIG. 4 and indicated generally by reference number 100. As shown in FIG. 4, the system 100 includes a DC power source 102 having a pair of output terminals 104, 106, a DC load 108, a disconnect switch S1 coupled between the output terminal 104 and the DC load 108, an inductance L1, and a capacitor C1 coupled between a power side of the disconnect switch S1 and a reference potential. When the disconnect switch S1 opens, current (including any stored energy being discharged by the inductance L1) can flow through the capacitor C1 rather than the switch S1. In this manner, extended arcing across the switch contacts may be inhibited.

In the particular example shown in FIG. 4, the DC load includes input terminals 110, 112. The input terminal 110 is coupled to a load side of the disconnect switch S1. Further, the input terminal 112 is coupled to the capacitor C1 and the output terminal 106, which serves as the reference potential. The reference potential may also be coupled to earth ground.

The DC power source 102 is preferably a “soft DC power source,” meaning the DC power source has a defined open circuit voltage and a defined short circuit current, with its output voltage decreasing (linearly or otherwise) with increasing output current, and vice versa. One example of a soft DC power source is a photovoltaic power source (e.g., formed of one or more solar panels or cells). Therefore, when there is a short circuit condition in the system 100 (e.g., due to a fault in the DC load 108, because the soft DC power source is connected in reverse polarity, etc.), the voltage on the power side (and the load side) of the disconnect switch S1 drops to about zero volts.

The DC power source may be configured to supply high dc voltages, such as up to 600 VDC, up to 1200 VDC, etc.

The inductance L1 may represent various sources of inductance in the system 100, including the parasitic inductance of one or more electrical conductors (e.g., wires) coupled between the DC power source 102 and the DC load 108 and/or any inductance in the DC load 108 coupled between its input terminals 110, 112.

As shown in FIG. 4, the disconnect switch S1 may include only one pair of switch contacts (e.g., a single pole, single throw switch). Alternatively, the disconnect switch S1 may include multiple pairs of switch contacts operated simultaneously (e.g., a multi-pole, single throw switch) or independently (e.g., a double-pole, double throw switch) and connected in series. The disconnect switch may be a manually operated switch. Alternatively, the disconnect switch may be operated automatically by another device or control system (such as a relay, etc.).

Further, the system 100 may or may not include circuit breakers (e.g., current fuses) in addition to the disconnect switch S1.

In the system 100 of FIG. 4, only one capacitor is coupled between the input side of the disconnect switch S1 and the reference potential. In other embodiments, multiple capacitors may be employed. The capacitor C1 (and any other capacitors employed) may be safety rated capacitors, such as class X2 capacitors.

The DC load 108 may be, for example, a switch mode power supply (SMPS). Further, if the DC power source is a photovoltaic power source, the SMPS load may be configured to implement a maximum power point tracking (MPPT) function. The SMPS may be, e.g., a DC/DC converter or a DC/AC converter (also referred to as an inverter). If the SMPS is an inverter, the inverter may be configured to implement an MPPT function and/or may be a grid-tie inverter for supplying AC power to a utility grid. Alternatively, other types of DC loads may be employed without departing from the scope of the present disclosure.

While not shown in FIG. 4, additional components may be employed between the disconnect switch S1 and the DC power source 102, and/or between the disconnect switch S1 and the DC load 108.

When the disconnect switch S1 is opened during a short circuit condition, a short circuit current will flow through the capacitor C1, causing the capacitor C1 to absorb any energy discharged by the inductance L1. During this time, the voltage across the disconnect switch S1 will slowly rise, as the capacitor C1 charges. The value of C1 can be selected to prevent the voltage across the disconnect switch S1 from exceeding a defined voltage before the disconnect switch S1 is fully opened, so as to inhibit extended arcing in the disconnect switch S1. The defined voltage may be, for example, 100 VDC, or any other suitable voltage.

The value of the capacitor C1 may be calculated based on the value of the inductance L1 and the maximum short circuit current. At maximum short circuit current (Isc), the energy stored in the inductance L1 is about 0.5*L1*Isc². The parasitic inductance of wiring is typically about 10 nH/inch. Therefore, if the inductance L1 is primarily attributable to the parasitic inductance of the wiring, and if the wiring is about one hundred feet in length, the value of the inductance L1 may be about 12 microH. In that event, if the maximum short circuit current Isc is limited to about 12 ADC, the value of the capacitor C1 may be selected to be about 0.47 uF.

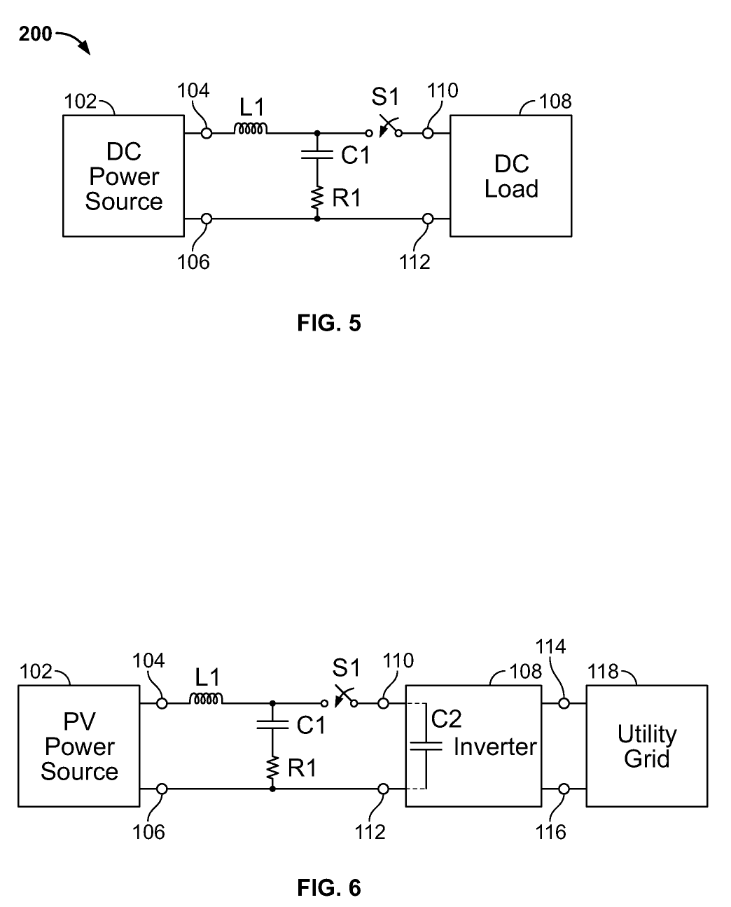

FIG. 5 illustrates a system 200 according to another example embodiment. The system 200 is similar to the system 100 of FIG. 4, but includes a resistor R1 coupled in series with the capacitor C1. The resistor R1 may be employed, e.g., to limit inrush current from the capacitor C1 (when charged) to the DC load when the disconnect switch S1 is closed. For some applications, the value of the resistor R1 may be very small, such as a few Ohms. In other applications, or if the value of capacitor C1 is small, the resistor R1 may be eliminated.

FIG. 6 illustrates one preferred implementation of the system 200 of FIG. 5, where the DC power source 102 is a photovoltaic (PV) power source, and the DC load 108 is an inverter having a filter capacitance C2 coupled between its input terminals 110, 112. The inverter 108 includes output terminals 114, 116 coupled to a utility grid. In this example implementation, the value of the capacitor C1 is 2.2 uF, the value of the resistor R1 is 10 ohms, the short circuit current of the PV power source is 10 ADC, and the open circuit voltage of the PV power source is 450 VDC.

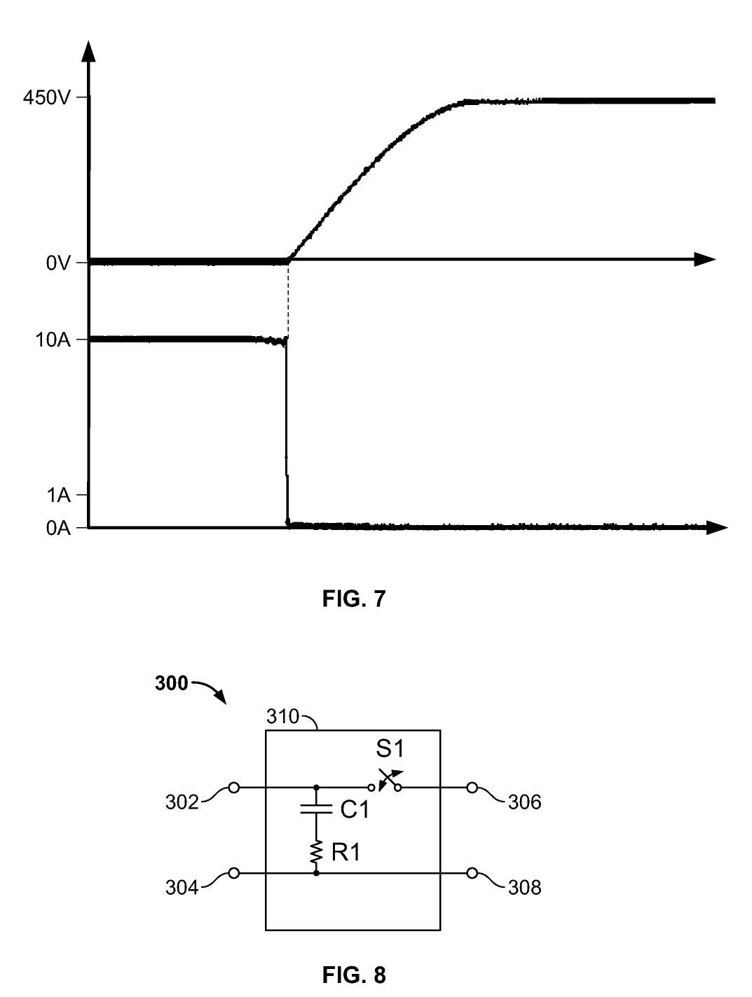

FIG. 7 illustrates current and voltage waveforms for the disconnect switch S1 in FIG. 6 as the disconnect switch S1 is opened during a short circuit condition on its load side. As shown in FIG. 7, the voltage across the disconnect switch remains low (e.g., about zero volts) until the current through the disconnect switch S1 falls below the typical arcing level of 1 ADC. In this manner, extended arcing in the disconnect switch S1 is substantially inhibited (and may be prevented altogether).

FIG. 8 illustrates a DC disconnect switch assembly 300 according to another example embodiment of the present disclosure. The assembly 300 includes a pair of input terminals 302, 304 for coupling to a DC power source, a pair of output terminals 306, 308 for coupling to a DC load, a disconnect switch S1 coupled between input terminal 302 and output terminal 306, and a capacitor C1 coupled between the input terminals 302, 304. The disconnect switch S1 may be operated manually or automatically, as noted above.

In the particular example shown in FIG. 8, the input terminal 304 is electrically shorted to the output terminal 308.

As shown in FIG. 8, the assembly 300 may further include a resistor R1 coupled in series with the capacitor C1. Alternatively, the resistor R1 may be omitted.

The assembly 300 may also include a housing 310 for enclosing the disconnect switch S1, the capacitor C1 and/or the resistor R1.

The assembly 300 may also include additional components not shown in FIG. 8. Alternatively, the assembly 300 may be limited to the particular components shown in FIG. 8 and, as noted above, may or may not include the resistor R1 and/or the housing 310.

For a typical residential 5 kW photovoltaic array having an open circuit voltage of 600V, the disconnect switch may have a maximum current rating in the range of 15 ADC to 40 ADC and a maximum voltage rating of 750 VDC. The capacitor may have a capacitance of, e.g., about 0.47 uF to about 3.3 uF. Further, the resistor R1 (if employed) may have a resistance of, for example, about 5 ohms to about 50 ohms. It should be understood, however, that other ratings and/or component values may be employed in any given implementation without departing from the scope of this disclosure.

The teachings of this disclosure may be applied to a variety of applications including, without limitation, residential and/or grid-tied PV power applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system comprising:
a soft DC power source having an output terminal;
a DC load;
a disconnect switch coupled between the output terminal of the soft DC power source and the DC load, the disconnect switch having a power side and a load side; and
a capacitor coupled between the power side of the disconnect switch and a reference potential, the capacitor inhibiting a rise in voltage across the disconnect switch as the disconnect switch is opening to inhibit arcing in the switch.

2. The system of claim 2 further comprising one or more electrical conductors having a parasitic inductance coupled between the soft DC power source and the DC load.

3. The system of claim 1 wherein the capacitor has a capacitance sufficient to prevent a voltage across the disconnect switch from exceeding a defined voltage as the disconnect switch is opening.

4. The system of claim 3 wherein the defined voltage is about 100 VDC.

5. The system of claim 1 wherein the disconnect switch is a single pole, single throw switch.

6. The system of claim 1 wherein the disconnect switch is a manually operated switch.

7. The system of claim 1 further comprising a resistor coupled in series with the capacitor.

8. The system of claim 1 wherein the DC load includes a switch-mode power converter.

9. The system of claim 8 wherein the switch-mode power converter is configured to implement a maximum power point tracking (MPPT) method.

10. The system of claim 8 wherein the switch-mode power converter is an inverter for converting DC power to AC power.

11. The system of claim 10 wherein the inverter is a grid-tie inverter.

12. The system of claim 1 wherein the soft DC power source is a photovoltaic power source.

13. A DC disconnect switch assembly, the assembly comprising:
a pair of input terminals for coupling to a DC power source;
a pair of output terminals for coupling to a DC load;
a disconnect switch coupled between one of the input terminals and one of the output terminals; and
a capacitor coupled between the pair of input terminals.

14. The assembly of claim 13 wherein the disconnect switch has a maximum current rating in a range of about 15 ADC to about 40 ADC, and a maximum voltage rating of about 750 VDC.

15. The assembly of claim 13 wherein the capacitor has a capacitance in a range of about 0.47 uF to about 3.3 uF.

16. The assembly of claim 13 further comprising a resistor coupled in series with the capacitor.

17. The assembly of claim 16 wherein the resistor has a resistance of about 5 ohms to about 50 ohms.

18. The assembly of claim 13 further comprising an enclosure, wherein the disconnect switch and the capacitor are positioned in the enclosure.

19. The assembly of claim 13 wherein one of the input terminals is electrically shorted to one of the output terminals.

20. The assembly of claim 13 wherein the disconnect switch is a manually operated switch.
